(19) United States
(12) Patent Application Publication
(10) Pub. No.: US 2025/0202155 A1
(43) Pub. Date: Jun. 19, 2025

(54) Connector and Power Device Comprising the Same

(71) Applicant: Tyco Electronics (Shanghai) Co., Ltd., Shanghai (CN)

(72) Inventors: Jiaoyong (Mac) Liu, Shanghai (CN); Liqiang (Gino) Yao, Shanghai (CN); Wei Yao, Kunshan (CN)

(73) Assignee: Tyco Electronics (Shanghai) Co., Ltd., Shanghai (CN)

(21) Appl. No.: 18/985,159

(22) Filed: Dec. 18, 2024

(30) Foreign Application Priority Data
Dec. 18, 2023 (CN) 202311746578.7

(51) Int. Cl. H01R 13/502; H01R 12/77; H01R 13/24; H01R 13/623; H01R 107/00

(52) U.S. Cl. CPC H01R 13/502; H01R 12/771; H01R 13/24; H01R 13/623; H01R 2107/00

(57) ABSTRACT

A connector includes a cable having a plurality of wires, a first inner sleeve provided on an end of the cable, a first outer sleeve fixedly connected to the first inner sleeve and having a first flange protruding radially inwards, a first hub provided inside the first outer sleeve and accommodating an end of each of the plurality of wires extending from the cable into the first outer sleeve, and a first reinforcement member arranged between the first hub and the first flange. The first hub is not movable relative to the first outer sleeve under an external force.

### CROSS-REFERENCE TO RELATED APPLICATION

This application claims the benefit of the filing date under 35 U.S.C. § 119 (a)-(d) of Chinese Patent Application No. 202311746578.7, filed on Dec. 18, 2023.

### FIELD OF THE INVENTION

The present disclosure relates to a connector and a power device comprising the connector.

### BACKGROUND OF THE INVENTION

A connector is a device used to connect two active devices to transmit current or signals. A connector may simplify an assembly process of electronic product and also simplify a mass production process of the electronic products. A connector is easy to repair, and if an electronic component fails, the failed component may be quickly replaced with a connector installed. With an advancement of technology, the electronic product equipped with a connector may use updated electronic components, replacing old electronic components with new and better performing ones for easy upgrading. A connector may enhance a flexibility of product design when designing and integrating a new product, as well as when composing a system with electronic components. Therefore, connectors are widely used in fields such as transportation, healthcare, aerospace, military, and home appliances.

The basic performances of a connector may be divided into three categories: mechanical performance, electrical performance, and environmental performance.

Insertion and extraction force and mechanical life are important mechanical performances. The insertion and extraction force and mechanical life of a connector are related to a structure of a contact (a magnitude of a positive pressure), a quality of a coating on a contact area (sliding friction coefficient), and an accuracy of a size of an arrangement of the contacts (alignment precision).

Main electrical performances of a connector comprise a contact resistance, an insulation resistance, and a dielectric strength. Among them, a high-quality electrical connector should have a low and stable contact resistance, which ranges from a few milliohms to tens of milliohms. An insulation resistance is an index that measures the insulation performance between the contacts of an electrical connector and between the contacts and a housing of the connector. An order of magnitude of the insulation resistance ranges from hundreds of megaohms to thousands of megaohms. Dielectric strength is an ability of a connector to withstand a rated test voltage between the contacts of the connector or between the contacts and the housing.

Environmental performance comprises a temperature resistance, a humidity resistance, a salt spray resistance, a vibration, and an impact resistance, etc.

The development of connector technology presents the following characteristics: high-speed and digitalization of signal transmission, integration of various signal transmissions, miniaturization of product volume, low cost of products, modular combination, convenience of insertion and extraction, and so on.

A connector used in a power device such as a power module for communication equipment typically comprises a longer cable, which may generate significant stress in the cable during transportation of the power device or other situations that may cause vibration of the power device. This may result in displacement of components connected at both ends of the cable due to the press, posing a risk of short circuit or open circuit of electrical connection, increasing maintenance costs, and reducing reliability of the power device.

### SUMMARY OF THE INVENTION

A connector includes a cable having a plurality of wires, a first inner sleeve provided on an end of the cable, a first outer sleeve fixedly connected to the first inner sleeve and having a first flange protruding radially inwards, a first hub provided inside the first outer sleeve and accommodating an end of each of the plurality of wires extending from the cable into the first outer sleeve, and a first reinforcement member arranged between the first hub and the first flange. The first hub is not movable relative to the first outer sleeve under an external force.

### BRIEF DESCRIPTION OF THE DRAWINGS

The invention will now be described by way of example with reference to the accompanying figures, of which:

FIG. 1 is a perspective view of a connector according to an embodiment;

FIG. 2 is a cross-sectional view taken along line II-VIII in FIG. 1, showing a first reinforcement member according to a first embodiment of the present disclosure installed at one end of the cable;

FIG. 3 is a side view showing a plurality of components installed at the one end of the cable in FIG. 1, with a first outer sleeve being omitted so as to illustrate the first reinforcement member according to the first embodiment;

FIG. 4 is a side view showing a plurality of components installed at the one end of the cable in FIG. 1, with the first outer sleeve and a first hub being omitted so as to illustrate the first reinforcement member according to the first embodiment;

FIG. 5 is a perspective view of FIG. 4, showing the first reinforcement member according to the first embodiment of the present disclosure installed on a plurality of wires;

FIG. 6 is a perspective view of the first reinforcement member in FIG. 5;

FIG. 7 is an exploded view of the first reinforcement member in FIG. 6;

FIG. 8 is a cross-sectional view taken along line II-VIII in FIG. 1, showing the first reinforcement member according to a second embodiment of the present disclosure installed at the one end of the cable;

FIG. 9 is a cross-sectional view taken along line IX-IX in FIG. 1, showing the first reinforcement member according to the second embodiment of the present disclosure installed at the one end of the cable; and

FIG. 10 is a perspective view of the first reinforcement member according to the second embodiment in FIG. 8.

### DETAILED DESCRIPTION OF THE EMBODIMENT(S)

The features disclosed herein will become more apparent in the following detailed description in conjunction with the accompanying drawings, where similar reference numerals identify corresponding components. In the accompanying drawings, similar reference numerals typically represent identical, functionally similar, and/or structurally similar components. Unless otherwise stated, the drawings provided throughout the entire disclosure should not be construed as drawn to scale.

In order to make the purpose, technical scheme, and advantages of the present disclosure more clear, the following is a detailed explanation of the present disclosure, combined with specific embodiments and referring to the attached drawings. However, it should be understood that these descriptions are only illustrative and not intended to limit the scope of the present disclosure. In the following detailed description, for ease of interpretation, many specific details are elaborated to provide a comprehensive understanding of the embodiments of the present disclosure. However, it is evident that one or more embodiments may also be implemented without these specific details. In addition, in the following explanation, the description of the well-known technology is omitted to avoid unnecessary confusion with the concept of the present disclosure.

The terms used here are only for describing specific embodiments and are not intended to limit the present disclosure. The term “comprising” used here indicates the existence of features, steps, and operations, but does not exclude the existence or addition of one or more other features.

In the case of using expressions such as “at least one of A, B, and C, etc.” or the like, it should generally be interpreted in accordance with the meaning of the expressions that those skilled in the art usually understand (for example, “a system with at least one of A, B, and C” should comprise but not be limited to a system with only A, a system with only B, a system with only C, a system with A and B, a system with A and C, a system with B and C, and/or a system with A, B, C, etc.).

All terms used here (comprising technical and scientific terms) have the meanings commonly understood by those skilled in the art, unless otherwise defined. It should be noted that the terms used here should be interpreted as having a meaning consistent with the context of this specification and should not be interpreted in an idealized or overly rigid manner.

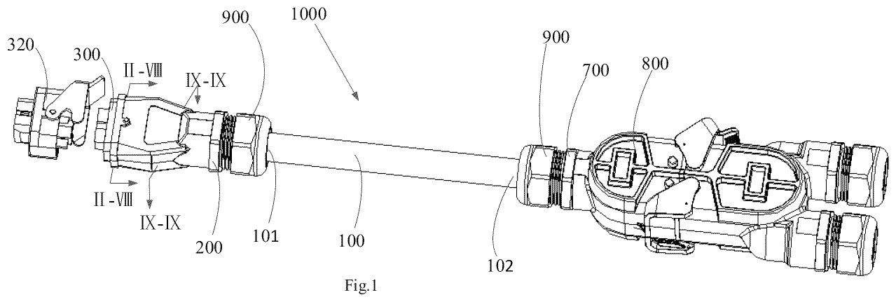

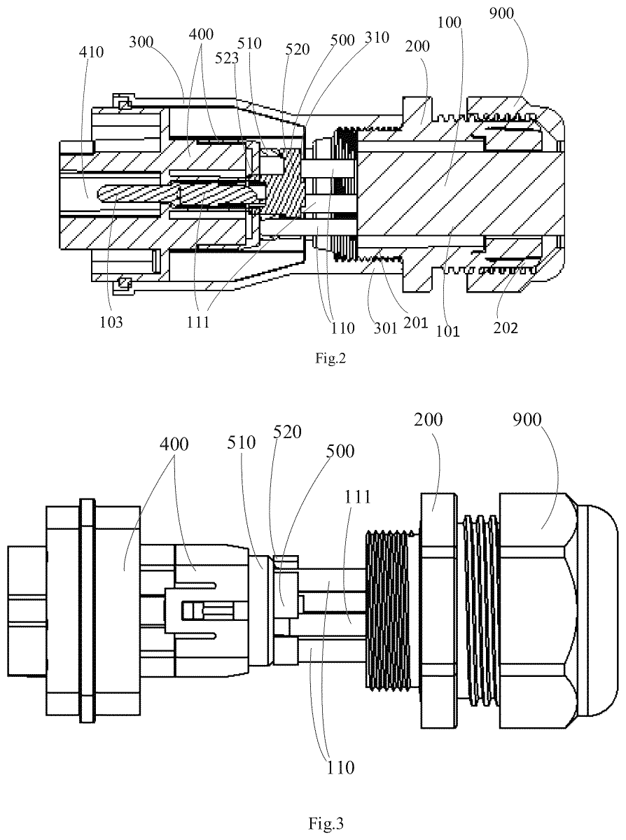

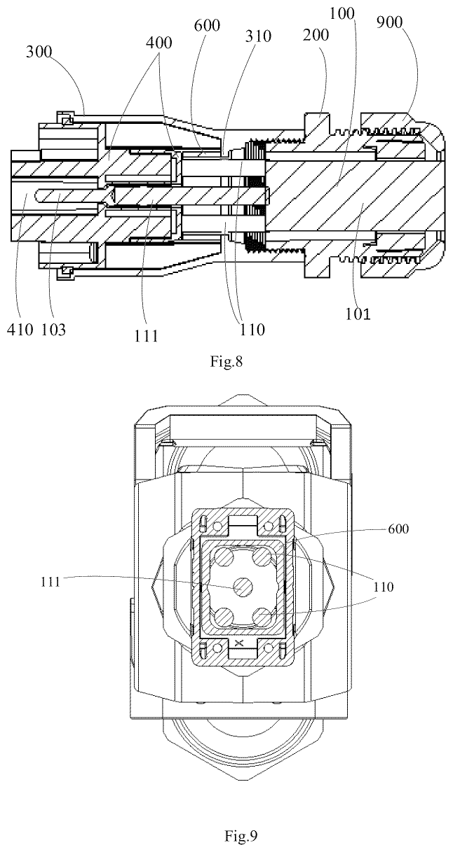

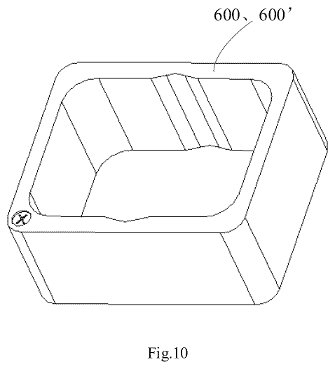

Referring to FIG. 1, the present disclosure discloses a connector 1000, which is commonly used in a power device such as a power module for communication equipment. The connector 1000 comprises a cable 100, a first inner sleeve 200, a first outer sleeve 300, a first hub 400, and a first reinforcement member 500, 600 (FIGS. 2 to 7 show the first reinforcement member 500 according to a first embodiment of the present disclosure, and FIGS. 8 to 10 show the first reinforcement member 600 according to a second embodiment of the present disclosure).

The cable 100 contains a plurality of wires 110, 111, shown in FIGS. 2 to 5. The first inner sleeve 200 is provided on one end 101 of the cable 100, so that the cable 100 extends through the first inner sleeve 200. A first end 301 of the first outer sleeve 300 is fixedly connected to a first end 201 of the first inner sleeve 200 through threads and accommodates the first end 201 of the first inner sleeve 200.

A second end 202 of the first inner sleeve 200 is provided with a fastener 900, as shown in FIG. 2, so as to further press the second end 202 against and fix the second end 202 to the one end 101 of the cable 100. The first outer sleeve 300 is provided with a first flange 310 protruding radially inwards on the side of the first end 301 away from the end 101 of the cable 100. The first hub 400 is provided inside the first outer sleeve 300 and is provided with a conductive channel 410, shown in FIG. 2, which is used to accommodate one end of each of the plurality of wires 110, 111 extending from one end 101 of the cable 100 into the first outer sleeve 300.

As shown in FIG. 2, the one end of each of the plurality of wires 110, 111 is provided with a conductive terminal 103 for electrical connection with a mating connector installed on the connector 1000 through an adapter 320 (see FIG. 1). The first reinforcement member 500, 600 is abutted against between the first hub 400 and the first flange 310, so that the first hub 400 connected to the cable 100 may not be moved relative to the first outer sleeve 300 under an external force during transportation of the power device or when the cable 100 is subjected to the external force under harsh environmental conditions, thereby fixing positions of the plurality of wires 110, 111, ensuring reliability of the electrical connection between the connector 1000 and the mating connector, greatly reducing a risk of short circuit or open circuit of electrical connection of the connector 1000, and reducing maintenance cost of the connector 1000 and the power device installed with the connector 1000.

The following describes a first reinforcing member 500 according to the first embodiment of the present disclosure with reference to FIGS. 2 to 7, which comprises a first ring 510 and a first receiving member 520.

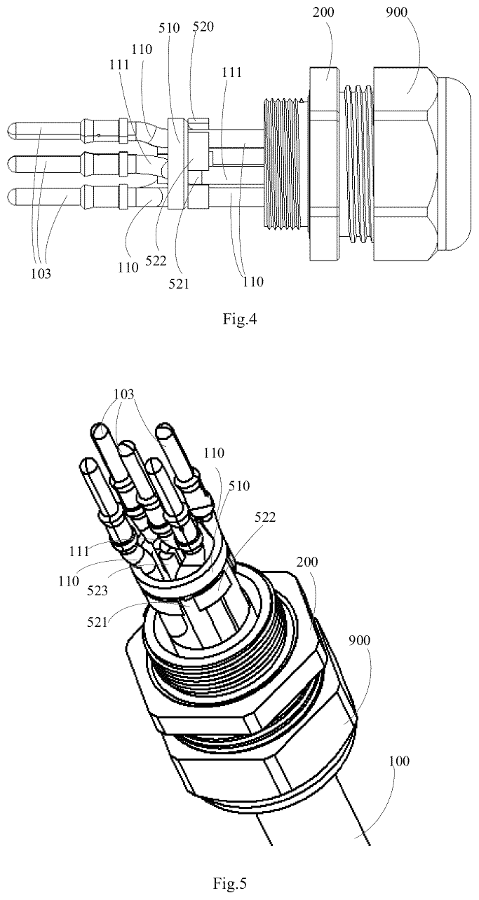

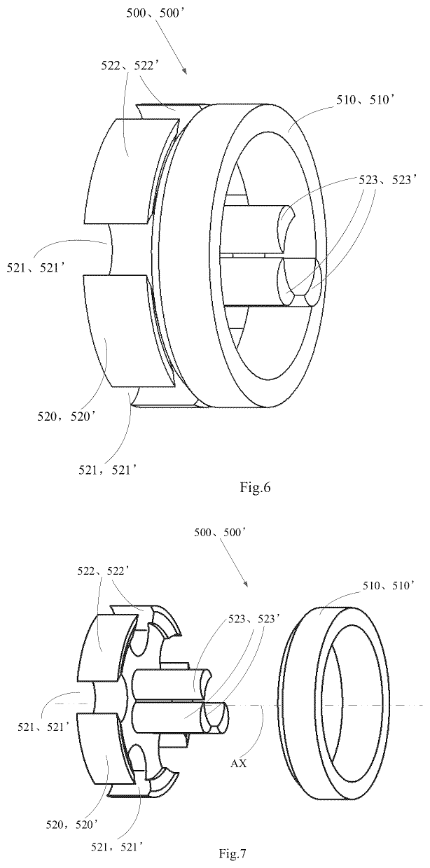

The first ring 510 is used to radially constrain the plurality of wires 110, 111 extending therethrough, as shown in FIGS. 4 and 5. The first receiving member 520 comprises a plurality of first receiving slots 521 provided along its circumference, each of which is configured for receiving and fixing corresponding one of the wires 110, 111 extending therethrough; and a plurality of first mating portions 522, each of which is provided between adjacent two of the first receiving slots 521 and is mating with the first ring 510 (see FIGS. 6 and 7). Each of the first receiving slots 521 is used to accommodate one of the wires 110, 111, and the number and size of the first receiving slots 521 may be set according to the number of wires.

Referring to FIG. 2, the first mating portion 522 is abutted against the first flange 310 on its side away from the first ring 510, and the first ring 510 is abutted against the first hub 400 on its side away from the first receiving member 520.

As shown in FIGS. 5 to 7, the first receiving member 520 further comprises a plurality of first fingers 523, each of the first fingers 523 is provided with a crescent cross section, located close to a center of the first receiving member 520 and extends through the first ring 510 from the first receiving member 520, so that free ends of the plurality of first fingers 523 respectively abut against the first hub 400 (see FIG. 2), and thus the first hub 400 may not be moved relative to the first outer sleeve 300 under an external force. Two of the plurality of first fingers 523 are configured to face towards and are spaced apart from each other, so that one end of the wire 111 located between the two first fingers 523 extends along an axis AX passing through the center of the first receiving member 520, causing one wire 111 to be centered and the other four wires 110 to be located around the wire 111, facilitating the wires 110, 111 to be respectively received in the corresponding conductive channels 410 of the first hub 400. Although three first fingers 523 are shown in the embodiment of the present disclosure, those skilled in the art should understand that this is only exemplary, and the relative positions, the shape of the cross sections, and number of the first fingers 523 may be set according to actual needs, so that the wires 110, 111 are respectively received in the corresponding conductive channels 410 of the first hub 400, achieving reliable electrical connection.

FIGS. 8 to 10 illustrate a first reinforcement member 600 according to a second embodiment of the present disclosure, which is configured as a sleeve with a rectangular cross section such that the wires 110, 111 extend directly through the first reinforcement member 600 to be respectively received in the corresponding conductive channels 410 of the first hub 400.

Although only two embodiments of the first reinforcement member are shown in the present disclosure, those skilled in the art may understand that this is not limiting and the structure and shape of the first reinforcement member may be set according to actual needs, so that the first hub 400 may not be moved relative to the first outer sleeve 300 under the external force.

Referring to FIG. 1, the connector 1000 includes a second inner sleeve 700, a second outer sleeve 800, a second hub (the structure of the second hub is similar to that of the first hub 400, and for the sake of simplicity, it is not shown in the figures), and a second reinforcement member. The second inner sleeve 700 is provided on the other end 102 of the cable 100. The first end of the second outer sleeve 800 is fixedly connected to the first end of the second inner sleeve 700 through threads and accommodates the first end of the second inner sleeve 700. The second end of the second inner sleeve is provided with a fastener 900 (see FIG. 1) to further press and fix the second end of the second inner sleeve onto the other end 102 of the cable 100.

The second outer sleeve 800 is provided with a second flange protruding radially inwards on the side of its first end away from the end 102 of the cable 100 (an internal structure of the second outer sleeve 800 is similar to that of the first outer sleeve 300, and for the sake of simplicity, an internal structure of the second outer sleeve 800 is not shown in the figures). The second hub is provided inside the second outer sleeve 800 so as to accommodate the other end of each of the plurality of wires 110, 111 extending from the other end 102 of the cable 100 into the second outer sleeve 800. The second reinforcement members 500′, 600′ are abutted against between the second hub and the second flange, so that the second hub may not be moved relative to the second outer sleeve 800 under the external force, thereby further fixing the positions of the plurality of wires 110, 111 at the other ends of the plurality of wires 110, 111, further ensuring the reliability of the electrical connection between the connector 1000 and another mating connector connected to the second outer sleeve 800, further reducing the risk of short circuit or open circuit of electrical connection of the connector 1000, and further reducing the maintenance cost of the connector 1000 and related power device installed with the connector 1000.

Referring to FIGS. 6 and 7, the second reinforcement member 500′ has the same structure as the second reinforcement member 500, and the second reinforcement member 600′ has the same structure as the second reinforcement member 600.

As shown in FIGS. 6 and 7, the second reinforcement member 500′ comprises a second ring 510′ and a second receiving member 520′. The second ring 510′ is used to radially constrain the plurality of wires 110, 111 extending therethrough. The second receiving member 520′ comprises a plurality of second receiving slots 521′ provided along its circumference, each of which is configured for receiving and fixing corresponding one of the wires 110, 111 extending therethrough; and a plurality of second mating portions 522′, each of which is provided between adjacent two of the second receiving slots 521′ for mating with the second ring 510′. Each of the second receiving slots 521′ is used to accommodate one of the wires 110, 111, and the number and size of the second receiving slots 521′ may be set according to the number of wires.

The second mating portion 522′ is abutted against the second flange on its side away from the second ring 510′, and the second ring 510′ is abutted against the second hub on its side away from the second receiving member 520′, so that the second hub may not be moved relative to the second outer sleeve 800 under the external force.

As shown in FIGS. 6 and 7, the second receiving member 520′ further comprises a plurality of second fingers 523′. Each of the second fingers 523′ is provided with a crescent cross section, located close to the center of the second receiving member 520′ and extends through the second ring 510′ from the second receiving member 520′, so that free ends of the plurality of second fingers 523′ respectively abut against the second hub, and thus the second hub may not be moved relative to the second outer sleeve 800 under the external force.

Two of the plurality of second fingers 523′ are configured to face towards and being spaced apart from each other, so that the other end of the wire 111 located between the two second fingers 523′ extends along the axis AX passing through the center of the second receiving member 520′, causing one wire 111 to be centered and the other four wires 110 to be located around the wire 111, facilitating the wires 110, 111 to be respectively received in the corresponding conductive channels of the second hub. Although three second fingers 523′ are shown in the embodiments of the present disclosure, those skilled in the art should understand that this is only exemplary, and the relative positions, the shapes of the cross sections, and the number of the second fingers 523′ may be set according to actual needs, so that the wires 110, 111 are respectively received in the corresponding conductive channels of the second hub.

FIGS. 8 to 10 show a second reinforcement member 600′ according to a second embodiment of the present disclosure, which is configured as a sleeve with a rectangle cross section, allowing the wires 110, 111 to extend directly through the second reinforcement member 600′ and be respectively received in the corresponding conductive channels of the second hub.

It should be noted that the implementation not shown or described in the accompanying drawings or the text of the specification are all forms known to the person skilled in the art that the present disclosure pertains to and have not been explained in detail. In addition, the above definitions of each of the components are not limited to the various specific structures, shapes, or methods mentioned in the embodiments, which may be easily modified or replaced by the person skilled in the art.

It should also be noted that, in specific embodiments of the present disclosure, unless otherwise expressly stated, the numerical parameters in this specification and the attached claims are approximate values that may be changed based on the desired characteristics obtained by the content of the present disclosure. Specifically, all numbers used in the specification and claims to represent the dimensions, range conditions, etc. of the composition should be understood as being modified by the term “approximately” in all cases. In general, the meaning of the expression refers to an inclusion of a specific number of +10% changes in some embodiments, +5% changes in some embodiments, +1% changes in some embodiments, and +0.5% changes in some embodiments.

The person skilled in the art may understand that the features recorded in various embodiments and/or claims of the present disclosure may be combined or incorporated in a plurality of ways, even if such combinations or incorporations are not explicitly recorded in the present disclosure. Specifically, without departing from the spirit and teachings of the present disclosure, the features recorded in various embodiments and/or claims of the present disclosure may be combined and/or incorporated in a plurality of ways. All these combinations and/or incorporations fall within the scope of the present disclosure.

The specific embodiments described above provide further detailed explanations of the purpose, technical scheme, and beneficial effects of the present disclosure. It should be understood that the above explanations are only specific embodiments of the present disclosure and are not intended to limit the present disclosure. Any modifications, equivalent replacements, improvements, etc. made within the spirit and principles of the present disclosure should be comprised in the protection scope of the present disclosure.

1. A connector, comprising:
a cable having a plurality of wires;
a first inner sleeve provided on an end of the cable;
a first outer sleeve fixedly connected to the first inner sleeve and having a first flange protruding radially inwards;
a first hub provided inside the first outer sleeve and accommodating an end of each of the plurality of wires extending from the cable into the first outer sleeve; and
a first reinforcement member arranged between the first hub and the first flange, the first hub is not movable relative to the first outer sleeve under an external force.

2. The connector according to claim 1, wherein the first reinforcement member includes a first ring radially constraining the plurality of wires extending therethrough.

3. The connector according to claim 2, wherein the first reinforcement member includes a first receiving member having:
a plurality of first receiving slots provided along its circumference, each of the first receiving slots receives a corresponding one of the wires extending therethrough; and
a plurality of first mating portions each disposed between adjacent two of the first receiving slots and mating with the first ring.

4. The connector according to claim 3, wherein each of the first mating portions abuts against the first flange on a side facing away from the first ring, the first ring abuts against the first hub on a side facing away from the first receiving member.

5. The connector according to claim 4, wherein the first receiving member has a plurality of first fingers adjacent to a center of the first receiving member and extending through the first ring from the first receiving member.

6. The connector according to claim 5, wherein a pair of first fingers of the plurality of first fingers face towards each other and are spaced apart from each other, an end of one of the wires is located between the pair of first fingers and extends along an axis passing through the center of the first receiving member.

7. The connector according to claim 6, wherein a free end of each of the plurality of first fingers abuts against the first hub.

8. The connector according to claim 6, wherein each of the plurality of first fingers has a crescent cross section.

9. The connector according to claim 1, wherein the first reinforcement member is a sleeve with a rectangular cross section.

10. The connector according to claim 1, further comprising:
a second inner sleeve provided on another end of the cable;
a second outer sleeve fixedly connected to the second inner sleeve and having a second flange protruding radially inwards;
a second hub provided inside the second outer sleeve and accommodating another end of each of the plurality of wires extending from the cable into the second outer sleeve; and
a second reinforcement member arranged between the second hub and the second flange, the second hub is not movable relative to the second outer sleeve under the external force.

11. The connector according to claim 10, wherein the second reinforcement member includes a second ring radially constraining the plurality of wires extending therethrough.

12. The connector according to claim 11, wherein the second reinforcement member includes a second receiving member having:
a plurality of second receiving slots provided along its circumference, each of the second receiving slots receives a corresponding one of the wires extending therethrough; and
a plurality of second mating portions each disposed between adjacent two of the second receiving slots and mating with the second ring.

13. The connector according to claim 12, wherein each of the second mating portions abuts against the second flange on a side of the second flange facing away from the second ring.

14. The connector according to claim 13, wherein the second ring abuts against the second hub on a side of the second hub facing away from the second receiving member.

15. The connector according to claim 14, wherein the second receiving member includes a plurality of second fingers adjacent to a center of the second receiving member and extending through the second ring from the second receiving member.

16. The connector according to claim 15, wherein a pair of second fingers of the plurality of second fingers face towards each other and are spaced apart from each other, another end of one of the wires is located between the pair of second fingers and extends along an axis passing through the center of the second receiving member.

17. The connector according to claim 16, wherein a free end of each of the plurality of second fingers abuts against the second hub.

18. The connector according to claim 16, wherein each of the plurality of second fingers has a crescent cross section.

19. The connector according to claim 10, wherein the second reinforcement member is a sleeve with a rectangular cross section.

20. A power device comprising the connector of claim 1.
